(19) United States
(12) Patent Application Publication
(10) Pub. No.: US 2009/0010345 A1
(43) Pub. Date: Jan. 8, 2009

(54) TDS-OFDMA COMMUNICATION CLOSED-LOOP POWER CONTROL

(75) Inventors: Lin Yang, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/143,298

(22) Filed: Jun. 20, 2008

Related U.S. Application Data
(60) Provisional application No. 60/947,599, filed on Jul. 2, 2007.

(51) Int. Cl. H04K 1/10

(52) U.S. Cl. 375/260

(57) ABSTRACT

In a TDS-OFDMA communications system, a frame structure comprising: a frame such that within a frame time, a transmitted signal comprising a preamble, a downlink sub-frame, and an uplink sub-frame; and interposed between OFDM symbols are guard intervals comprising known sequences being used for an estimation of a received power.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-070.

U.S. patent application Ser. No. ______ with attorney docket number LSFFT-072.

U.S. patent application Ser. No. ______ with attorney docket number LSFFT-071.

### REFERENCE TO RELATED APPLICATIONS

This application claims an invention which was disclosed in Provisional Application No. 60/947,599, filed Jul. 2, 2007 entitled “TDS-OFDMA Communication Closed-Power Control”. The benefit under 35 USC §19(e) of the United States provisional application is hereby claimed, and the aforementioned application is hereby incorporated herein by reference.

### FIELD OF THE INVENTION

The present invention relates generally to an application in a TDS-OFDMA (Time Domain Synchronous-Orthogonal Frequency Division Multiple Access) system, more specifically the present invention relates to TDS-OFDMA communication system closed-loop power control.

### BACKGROUND

TDS-OFDM (Time Domain Synchronous-Orthogonal Frequency Division Multiplexing) scheme is known. The scheme can be applied to both downlink and uplink wireless communications in a multiple access context. TDS-OFDM use known sequences within the guard intervals. Therefore, it is desirable to use the known sequences within the guard intervals for TDS-OFDMA communication closed-power control.

### SUMMARY OF THE INVENTION

In a TDS-OFDMA Communication System, known sequences within the guard intervals is used for wireless communication closed-power control.

In a TDS-OFDMA communications system, a frame structure comprising: a frame such that within a frame time, a transmitted signal comprising a preamble, a downlink sub-frame, and an uplink sub-frame is provided. Interposed between OFDM symbols are guard intervals comprise known sequences that are used for an estimation of a received power.

A method comprising the step of using a known sequence within a guard interval of an OFDMA system for power estimation is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDMA system in accordance with some embodiments of the invention.

FIG. 2 is an example of a novel frame structure for a TDS-OFDMA Communication System in accordance with some embodiments of the invention.

FIG. 3 is an example of a closed-loop power control for initial access terminals.

FIG. 4 is an example of a closed-loop power control for normal operations.

FIG. 5 is an example of a flowchart for closed-loop power control on initial access terminals.

FIG. 6 is an example of a flowchart for Closed-loop power control on normal operations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to using known sequences within the guard intervals is used for wireless communication closed-loop power control in a TDS-OFDMA Communication System for wireless communication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of using known sequences within the guard intervals being used for wireless communication closed-loop power control in a TDS-OFDMA Communication System. The non-processor circuits may include, but are not limited to, a radio receiver, a radio transmitter, signal drivers, clock circuits, power source circuits, and user input devices. As such, these functions may be interpreted as steps of a method to perform using known sequences within the guard intervals being used for wireless communication closed-loop power control in a TDS-OFDMA Communication System. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

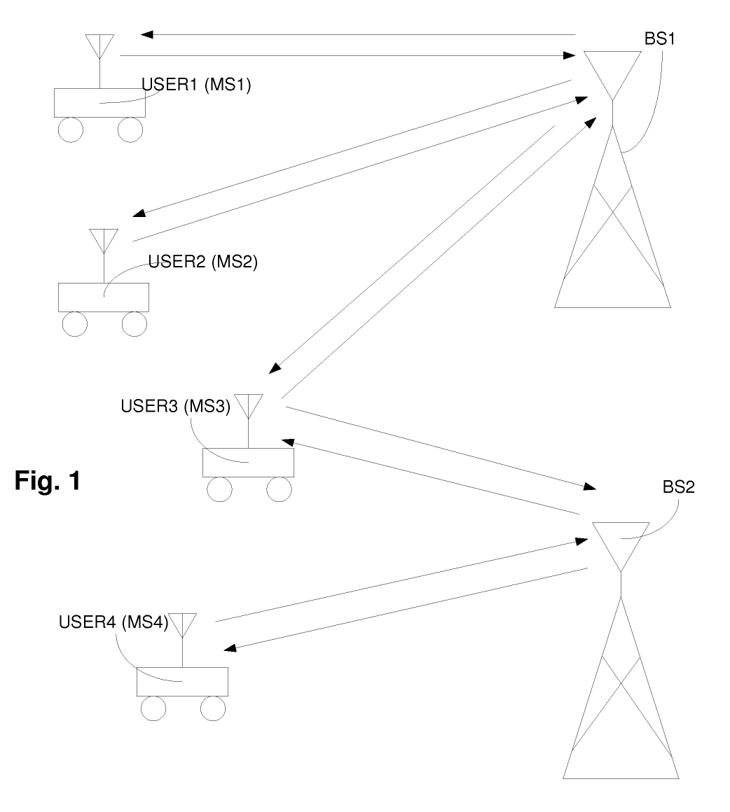

Referring to FIG. 1, a TDS-OFDM scheme 100 is applied to both downlink and uplink wireless communication. A plurality of users or mobile stations (only four, i.e. User1, User2, User3, and User4 are shown) associated with a plurality of base stations (only two, i.e. BS1 and BS2 are shown) are uplinked and down-linked for multiple accesses.

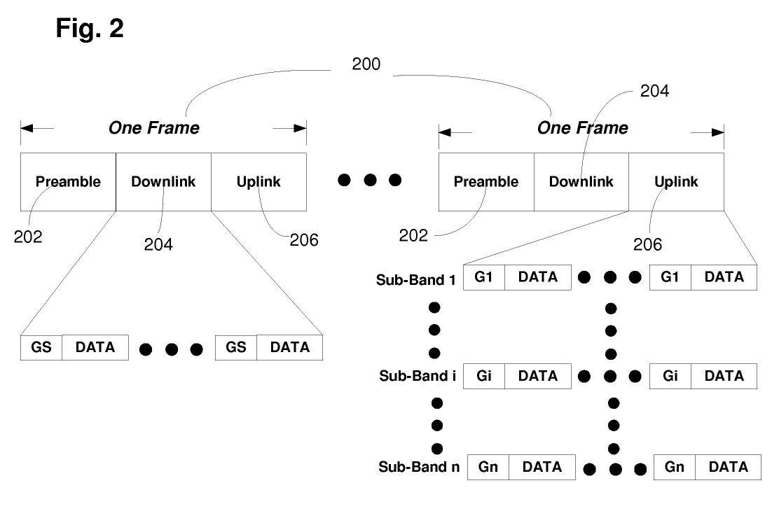

Referring to FIG. 2, a novel frame 200 structure for a TDS-OFDMA Communication System is shown. A transmission comprises a multiplicity of frames 200 is provided. For any one frame 200, there is included a preamble 202 portion, a downlink 204 portion, and an uplink 206 portion.

In a frame 200, the first set of symbols is used as the preamble 202 for synchronization and channel estimation purposes. The preamble 202 symbols can be constructed in many ways, such as a PN sequence, a frequency-domain PN sequence, or a frequency-domain segmented PN sequence similar to an IEEE 802.16 scheme. The preamble 202 positions can be at the first several symbol locations, at middle locations, or at distributed locations. The positions that are other than preamble 202 symbols are normal data symbols. The data symbols are formed of a guard interval and a data interval. The guard interval is a PN or known sequence and the data part is an OFDM symbol.

In the downlink 204, a TDS-OFDM signal is transmitted or broadcasted from, for example, transmitters of a base station. Each terminal listens to the channel and receives its own information through various ways, such as assigned time-frequency slots or connection ID, etc.

The downlink 204 signal is transmitted in a frame 200 based (transmitted frame 200 by frame 200) manner. In each frame 200, the transmitted signal is composed of multiple OFDM symbols. Each OFDM symbol comprises a PN or known sequence acting as the guard interval and a data portion as shown. When frequency reuse factor=1, the guard sequence and OFDM data may occupy the whole or part of an available bandwidth. The guard sequence and OFDM data may use the corresponding bandwidth. In the case where the frequency reuse factor is larger than 1, the available bandwidth is divided into more than 1 sub-band (not shown, but see Uplink 206 portion for sub-band depiction).

The sub-carriers in each sub-band may be contiguous where all the sub-carriers are adjoined and grouped together, or distributed where the sub-carrier may not necessary be adjoined and may be at any position inside the whole available band. The guard sequence and OFDM data may occupy the whole or a part of the assigned sub-bandwidth.

In the uplink 206, TDS-OFDM can also be used to achieve through sub-channelization, where the full-band is divided into multiple sub-bands, which means each user uses a portion of the available bandwidth and transmission time, to thereby achieve orthogonal, multiple access. The radio resource allocation is given by decoding the uplink map in the downlink 204 signal or by using the pre-assigned dedicated channels. The sub-carriers in each sub-band may be contiguous where all the sub-carriers are joined (adjacent) and grouped together, or distributed where the sub-carrier may not necessary be joined and may be at any position inside the available band.

Inside each sub-band, a TDS-OFDM signal is transmitted, which comprises a series of OFDM signals, where a PN or known guard sequence is used as the guard interval of each OFDM signal. Both the guard sequence and data signals are band-limited inside the sub-band to avoid the interference to other sub-bands.

In a frame 200, control information and radio resource management information are transmitted inside the data symbol. The control information provides the control of both downlink 204 and uplink 206. The radio resource management information provides radio resource allocation of both downlink 204 and uplink 206. Both control and radio resource management (RRM) information can be transmitted through assigned, dedicated channel or through downlink 204 map and uplink 206 map link as seen in the IEEE 802.16 scheme.

As can be seen, a TDS-OFDM communication system, wherein both uplink and downlink use TDS-OFDM signals is provided. Within a frame time, the transmitted signal is composed of a preamble, a downlink sub-frame, and an uplink sub-frame. The preamble may comprise one or several symbols. Furthermore, the preamble may be positioned at the front, the middle, or the last portion of the frame. Alternatively, the preamble may be distributed within the frame. The preamble symbol may be constructed by a time-domain PN sequence, a frequency-domain PN sequence, or partial-band frequency-domain PN sequence. Both the downlink and uplink sub-frame consists of multiple OFDM symbols. A downlink OFDM symbol comprises a guard interval and a data part, where the guard sequence is a time-domain PN sequence or other known sequence. For schemes having frequency reuse factor equal to 1, the guard sequence and OFDM data may occupy whole or partial available bandwidth. For frequency reuse factor larger than 1, the available bandwidth is divided into more than 1 sub-bands, where the sub-carriers in each sub-band may be contiguous where all the sub-carriers are adjoined and grouped together, or distributed where the sub-carrier may not be necessary be adjoined and may be at any position inside the available band. The guard sequence and OFDM data may occupy whole or partial assigned sub-bandwidth. In an uplink, the bandwidth is divided into multiple sub-bands. Where the sub-carriers in each sub-band may be contiguous where all the sub-carriers are adjoined and grouped together, or distributed where the sub-carrier may not be necessary be jointed and may be at any position inside the available band. Each user may use the radio resource allocated in time-frequency domain. The transmitted signal in each sub-band is composed of multiple OFDM symbols, where each OFDM symbol consists of a guard sequence and data. Both the guard sequence and data are band-limited to the assigned sub-band.

For the present invention, at least some OFDM symbols consist of a guard interval portion and a data portion. The guard interval may have pseudo noise (PN) sequences located therein. It is noted that the present invention contemplates using the PN sequence as guard intervals disclosed in U.S. Pat. No. 7,072,289 to Yang et al which is hereby incorporated herein by reference. However, other types of guard intervals are contemplated by the present invention as well. Inside the bandwidth for each user, at least one PN or known sequence is used as the guard interval between transmitted symbols, where the sequence is limited inside the sub-band.

The power control is needed both during the initial network access period and normal operation time period.

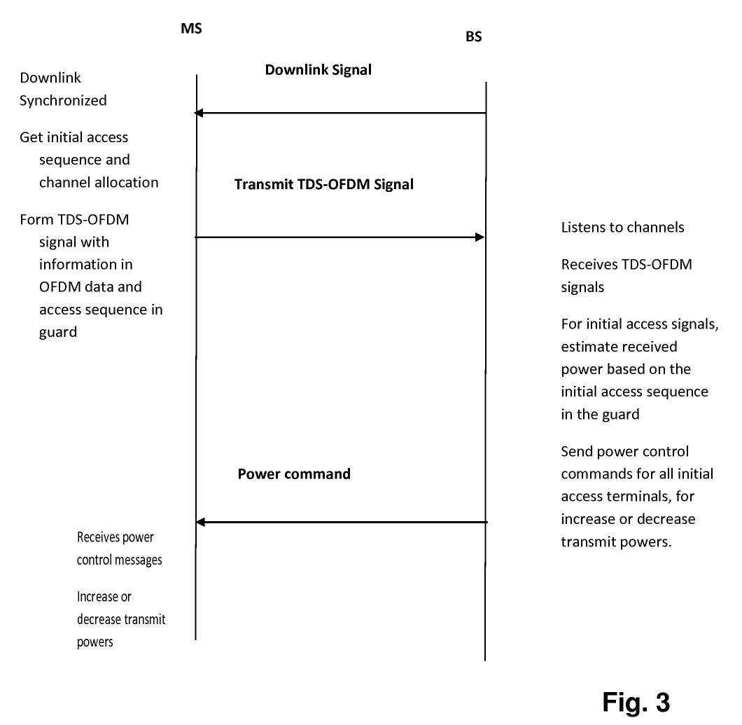

Referring to FIG. 3, closed-loop power control for initial access terminals is shown. For initial access, after downlink synchronization has been built, the terminal obtains available channel allocations and initial access sequences, selects a channel and an initial access sequence, and transmits the TDS-OFDM signal using the selected sequence as the guard interval over the selected channel. The OFDM data may be used to carry other information related to the communication. The base station listens to the channels and receives the TDS-OFDM signals. Using the receiving TDS-OFDM signal, the base station can use the access sequence at the guard interval to estimate the received power of each access terminal, and then transmits power control commands to the access terminals such the ones used by various users of FIG. 1. The transmit power between the base station and the mobile station is increased or decreased according to a predetermined means.

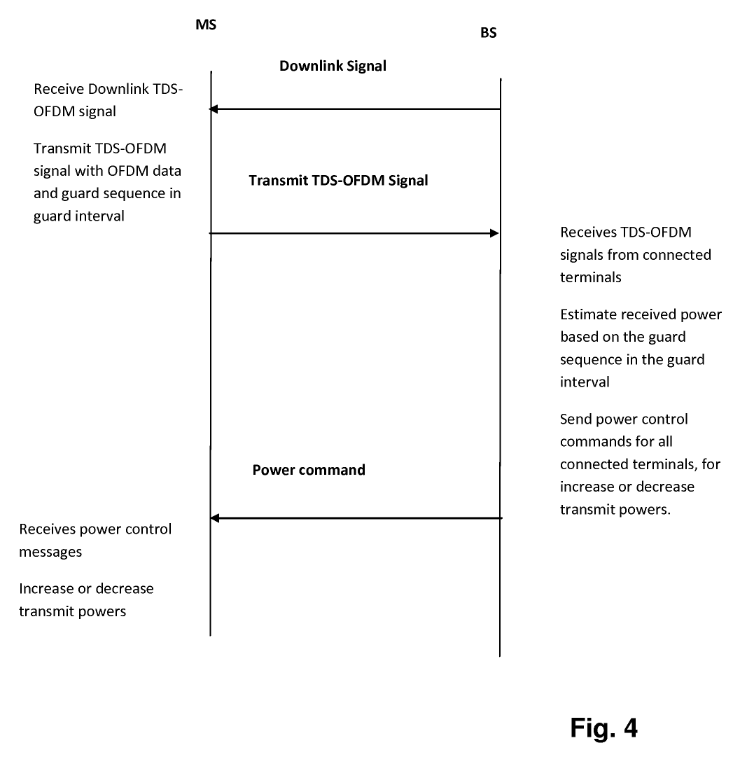

Referring to FIG. 4, closed-loop power control for normal operations is shown. For normal operations, the base station receives TDS-OFDM signals normally from all the connected users or mobile stations. Using the receiving TDS-OFDM signal, the base station can use the guard sequence at the guard interval to estimate the received power of each connected terminal, and then transmits power control commands to the connected terminals. The transmit power between the base station and the mobile station is increased or decreased according to a predetermined means.

The advantage of using guard sequence instead of the ranging channel method is the removal of ranging channel allocation resources or information to achieve resource-saving results as well as fast control response which is very critical in mobile communications.

As can be seen, the present invention relates to a TDS-OFDM communication system wherein both uplink and downlink use TDS-OFDM signals. In a time interval of a frame, the transmitted signal is composed of preambles, downlink sub-frames, and uplink sub-frames. The preamble may comprise of one or several symbols. Both the downlink and uplink sub-frame consists of multiple OFDM symbols. A downlink OFDM symbol comprises a guard interval and a data part, where the guard sequence is a time-domain PN sequence. The sub-carriers in the OFDM symbols may be continuous or distributed in a given bandwidth. In an uplink, the bandwidth is divided into multiple sub-bands, where the sub-carriers in the sub-band may be continuous or distributed. Each user of a mobile terminal or station uses the radio resource allocated in time-frequency domain. The transmitted signal in each sub-band is composed of multiple OFDM symbols, where each OFDM symbol consists of a guard sequence and OFDM data. Both the guard sequence and OFDM data are band-limited to the assigned sub-band, where the sub-carriers of the guard sequence and OFDM data may be continuous or distributed in the given bandwidth. The guard sequence in the guard intervals of the OFDM symbols of the received TDS-OFDM signals, both in the downlink and uplink, can be used to estimate at least one received power and the path loss in the corresponding channels. The estimated received powers or the path loss from transmitted terminals can be used to generate power control commands, which is sent from the base station to the terminals, to thereby increase or decrease the terminal transmit powers, for both the initial access and normal operated terminals.

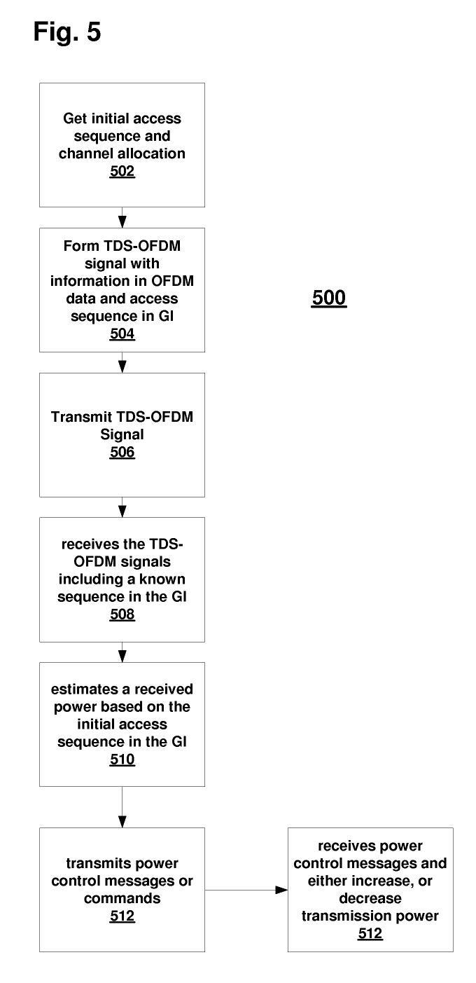

Referring to FIG. 5, a flowchart 500 for closed-loop power control on initial access terminals is shown. Downlink is synchronized by receiving a downlink signal including initial access sequence and channel allocation from base station (Step 502). The mobile station, in turn, Forms a set of TDS-OFDM signals with information in OFDM data and access sequence in guard interval (Step 504). The TDS-OFDM signals are transmitted from the mobile station to the base station (Step 506). On the base station side, it listens for signals within a predetermined number of channels. The base station receives the TDS-OFDM signals including a known sequence in the guard interval (GI) from the mobile station (Step 508). For initial access signals, the bases station estimates a received power based on the initial access sequence in the GI (Step 510). The base station send power control commands for all initial access terminals or mobile station. The power control commands include commands to either increase, or decrease transmission power for at least one mobile terminal. The base station transmits power control messages or commands to mobile station (Step 512). Each mobile station receives power control messages and either increase, or decrease transmission power in a predetermined manner (Step 512).

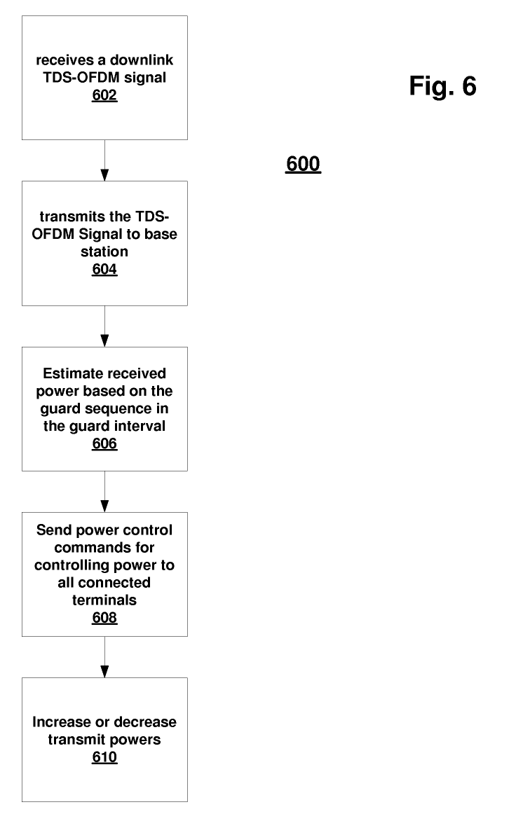

Referring to FIG. 6, a flowchart 600 for closed-loop power control on normal operations is shown. Downlink signal is transmitted from a based station to a mobile station among a plurality of connected mobile stations. A mobile station receives a downlink TDS-OFDM signal (Step 602). The mobile station transmits a TDS-OFDM signal with OFDM data along with at least one known guard sequence in guard interval (GI) and transmits the TDS-OFDM signal to base station (Step 604). The base station receives TDS-OFDM signals from at least some connected mobile terminals or users, and estimates the received power based on known guard sequence in the guard interval (Step 606). In turn, the base station sends a set of power control commands for controlling power to all connected mobile terminals to either increase, or decrease transmission powers (Step 608). Each mobile station receives power control messages from the based station based upon the power commands and makes a determination as to either increase, or decrease transmission power (Step 610).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A TDS-OFDM communications system comprising:
a frame such that within a frame time, a transmitted signal comprising a preamble, a downlink sub-frame, and an uplink sub-frame; and
interposed between OFDM symbols are guard intervals comprising known sequences being used for an estimation of a received power.

2. The system of claim 1, wherein both uplink and downlink use TDS-OFDM signals.

3. The system of claim 1, wherein both the downlink and uplink sub-frame consists of multiple OFDM symbols.

4. The system of claim 1, wherein the preamble may comprise one or more symbols.

5. The system of claim 1, wherein the preamble may be positioned at front, middle or last part of the frame, or distributed within the frame at different parts.

6. The system of claim 5, wherein the preamble symbol is constructed by a time-domain PN sequence, a frequency-domain PN sequence, or a partial-band frequency-domain PN sequence.

7. The system of claim 1, wherein a downlink OFDM symbol comprises a guard interval and a data part, within the guard interval at least one guard sequence is used, the guard sequence being at least one time-domain PN sequence.

8. The system of claim 1, wherein for a frequency reuse factor is one (frequency reuse factor=1), the guard sequence and OFDM data may occupy all or a part of an available bandwidth.

9. The system of claim 1, wherein for frequency reuse factor larger than 1 (frequency reuse factor>1), the available bandwidth is divided into at least two sub-bands, where sub-carriers in each sub-band are contiguous having all the sub-carriers joined and grouped together, or each sub-band are distributed having some sub-carriers free from joined and grouped together and be located at any position inside the whole available band.

10. The system of claim 1, wherein in the uplink, a bandwidth is divided into multiple sub-bands.

11. The system of claim 1, wherein the guard sequence and OFDM data occupy whole or partial assigned sub-bandwidth.

12. The system of claim 10, wherein the sub-carriers in each sub-band may be contiguous where all the sub-carriers are adjoined and grouped together.

13. The system of claim 10, wherein the sub-carrier is free from adjoining and positioned at any position inside an available band.

14. The system of claim 1, wherein the transmitted signal in each sub-band comprises multiple OFDM symbols, and wherein each OFDM symbol consists of a guard sequence and OFDM data with both the guard sequence and data are band-limited to the assigned sub-band.

15. The system of claim 1, wherein the guard sequence in the guard intervals of the OFDM symbols of the received TDS-OFDM signals, both in the downlink and uplink, can be used to estimate the received power.

16. The system of claim 1, wherein estimated received powers from transmitted terminals are used to generate power control commands sent from the base station to mobile terminals to either increase, or decrease the terminal transmission powers for both the initial access and normally operated terminals.

17. The system of claim 1, wherein each user uses the radio resource allocated in time-frequency domain.

18. The system of claim 1, wherein the transmitted signal in each sub-band is composed of multiple OFDM symbols, where each OFDM symbol includes a guard sequence and a data section.

19. The system of claim 18, wherein both the guard sequence and data are band-limited to an assigned sub-band and used for the power estimation.

20. A method comprising the step of using a known sequence within a guard interval of an OFDMA system for a power estimation.
